(19) United States
(12) Patent Application Publication
(10) Pub. No.: US 2017/0057670 A1
(43) Pub. Date: Mar. 2, 2017

(54) DISPENSING DEVICE

(71) Applicant: ORIPAN S.r.l., Tione di Trento (Trento) (IT)

(72) Inventor: Francesco FRANCHINI, Borgo Lares (Trento) (IT)

(73) Assignee: ORIPAN S.r.l., Tione di Trento (Trento) (IT)

(21) Appl. No.: 15/253,458

(22) Filed: Aug. 31, 2016

(30) Foreign Application Priority Data
Sep. 2, 2015 (IT) 102015000047938

(51) Int. Cl. B65B 1/30; B65B 1/06; G05D 7/06; B65B 1/32

(52) U.S. Cl. CPC B65B 1/30; B65B 1/32; B65B 1/06; G05D 7/0635; G05D 7/0676

(57) ABSTRACT

A device for dispensing an ingredient in the context of a process of preparation of a mixture for making a food product includes a structure for loading the ingredient and control means for controlling the flow of the ingredient from the loading structure to a structure for receiving the ingredient. An optical sensor in the range of visible light, is designed to detect an optical parameter of the aforesaid ingredient. A control unit is configured for governing the aforesaid control means on the basis of the signal received from the sensor.

The present invention relates to a device for dispensing ingredients for the preparation of a food mixture. In particular, of interest herein is the sector of processes for preparing doughs for foodstuffs, such as pizza, pasta, cakes, bread, etc. With reference to the dispensing step, in many of the known processes, including automatic ones, it is envisaged that for one or more ingredients dispensing is performed manually by an operator. In automatic processes, this may regard above all ingredients present in the dough in low or minimal percentages, such as sugar, leavening agents, salt, etc., whereas in semiautomatic processes like the ones carried out in craft bakeries this may regard even all the ingredients of the dough.

In such a context, the object of the present invention is to make available a dispensing device that will be able to provide an aid to the operator who carries out dispensing of the ingredient or ingredients manually, in particular that will be prearranged for enabling dispensing of the ingredients only after a check has been carried out on the effective correspondence of the ingredient loaded into the device with what is envisaged by the process.

The object referred to is achieved by a device presenting the characteristics specified in claim 1.

The ensuing claims form an integral part of the technical teaching provided herein in relation to the invention.

Further characteristics and advantages of the invention will emerge clearly from the ensuing description with reference to the annexed drawings, which are provided purely by way of non-limiting example and in which:

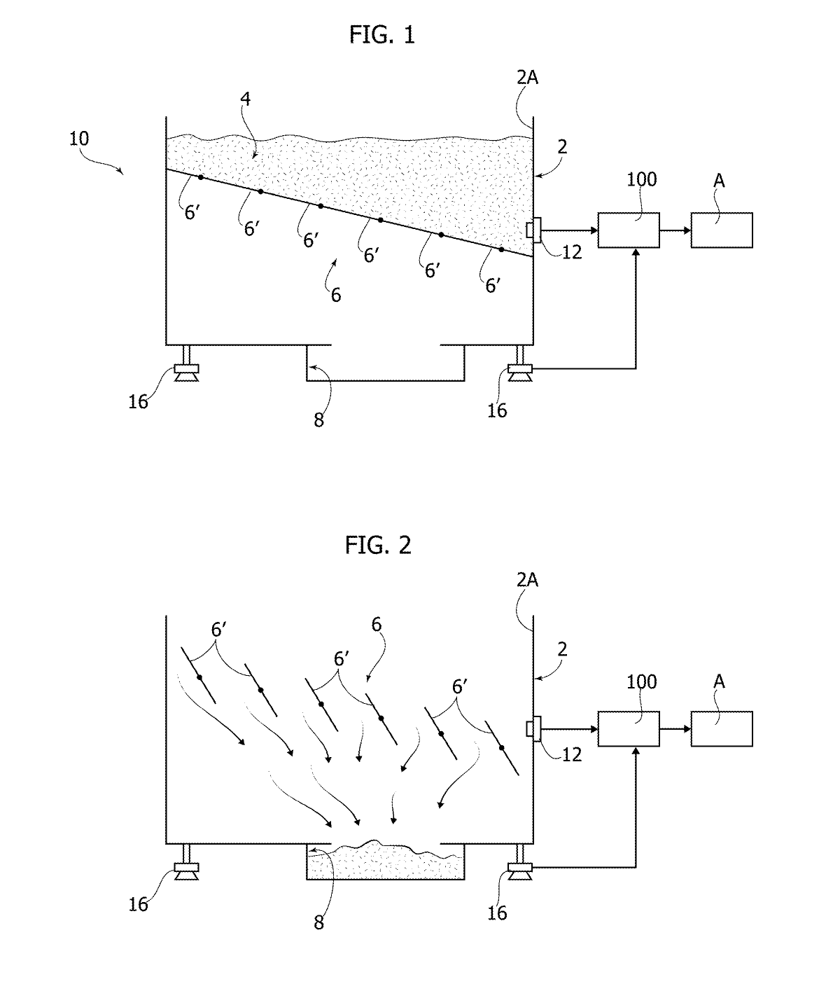

FIGS. 1 and 2 are schematic illustrations of an embodiment of the device described herein in two different operating conditions;

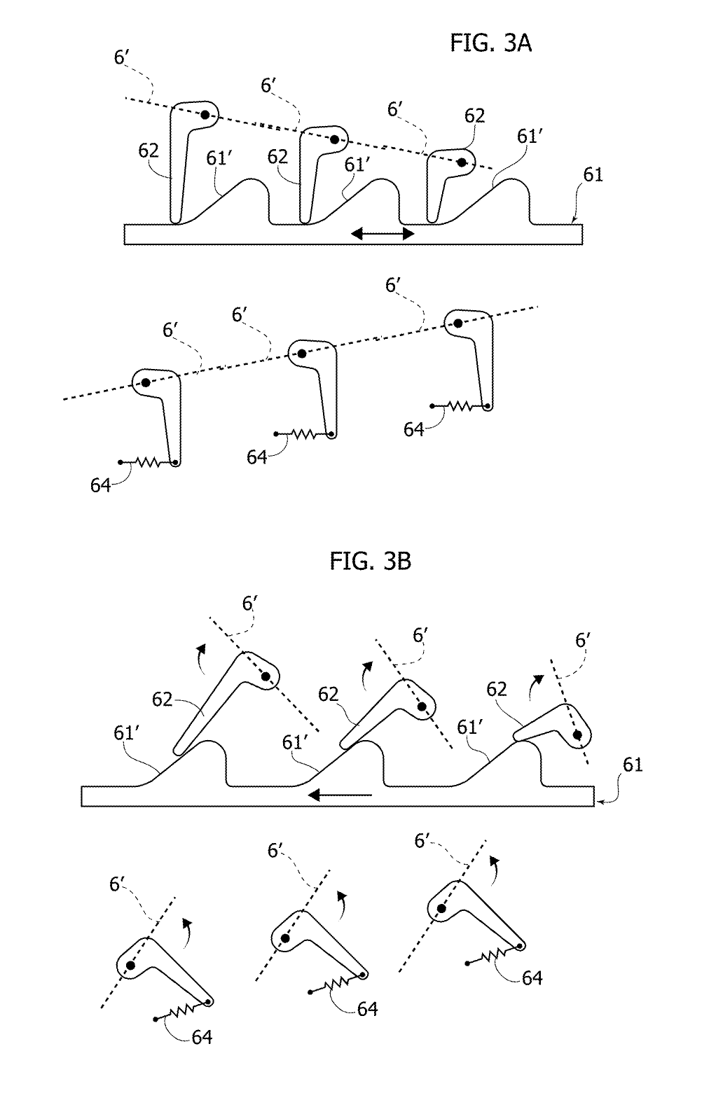

FIGS. 3A and 3B represent an embodiment of an actuation system provided in the device of FIG. 1, in two different operating conditions; and

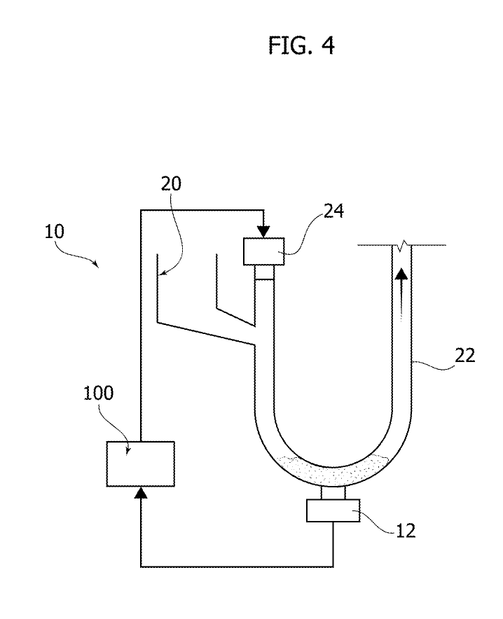

FIG. 4 is a schematic illustration of a further embodiment of the device described herein.

In the ensuing description, various specific details are illustrated, aimed at providing an in-depth understanding of the embodiments. The embodiments may be obtained without one or more of the specific details, or with other methods, components, or materials, etc. In other cases, known structures, materials, or operations are not illustrated or described in detail so that various aspects of the embodiment will not be obscured.

The references used herein are provided merely for convenience and hence do not define the sphere of protection or the scope of the embodiments.

As mentioned above, the device described herein is a device for dispensing ingredients for the preparation of food mixtures, in particular doughs, such as doughs for bread, pizza, pasta, cakes, etc.

As will be discussed in greater detail in what follows, the device described herein may present different configurations according to the specific applications for which it is to be used.

In general, the dispensing device described herein is characterized in that it is prearranged so as to subject the step of dispensing of the ingredient to a preliminary check on the type of ingredient that has been loaded into the device, enabling dispensing of the dough only in the case where the ingredient loaded corresponds to what is envisaged by the process.

In general, the device described herein comprises:
an optical sensor designed to detect an optical parameter of the ingredient; and
a control unit configured for generating a signal for enabling dispensing of the ingredient on the basis of a signal coming from the sensor.

The enabling signal in question may even just be a signal of a visual or acoustic type that informs the operator whether the ingredient analysed is or is not the one envisaged by the process.

In various embodiments, the device further comprises:
a structure for loading the ingredient; and
control means for controlling the flow of the ingredient from the loading structure to a structure for receiving the ingredient.

The control unit may be configured for governing the aforesaid means for controlling the flow of the ingredient, in an action tending to determine the aforesaid flow, via the above enabling signal. In this case, the enabling signal is hence a signal for governing the control means.

FIG. 1 illustrates an embodiment of the device described herein, which is particularly suited to being used in the context of a semiautomatic process, performed in a craft-type bakery, for preparing a dough for foodstuffs.

In various embodiments, as in the one illustrated in Figure q, the device—designated by the reference number 10—comprises a frame 2 shaped like a container, which defines the loading structure of the device. The frame 2 identifies at the top a chamber 4, accessible through the top opening 2A of the frame, within which the operator pours the ingredient to be dispensed. The chamber 4 is delimited at the bottom by a valve unit 6, which represents the aforesaid means for controlling the flow of the ingredient.

In various embodiments, as in the one illustrated, the valve unit 6 comprises a series of blades 6′ rotatably mounted on the frame 2 and governed via an appropriate actuation system between two end angular positions: a first position in which the blades 6′ are each in contact with the respective adjacent blades (or, for the two blades at the end of the series, with the individual adjacent blade and one of the walls of the frame 2), at their longitudinal edges, and as a whole define a barrier designed to prevent passage of the ingredient contained in the chamber 4 into the bottom part of the frame 2; and a second position in which, with respect to the first position, the blades are inclined upwards and are no longer in contact with one another so as to define, between the various pairs of adjacent blades, a series of respective passages through which the ingredient can drop by gravity into the underlying part of the frame 2.

The system designed to operate the blades between the two positions indicated may be of different types, taking also into account the overall dimensions and the costs envisaged for the device in the individual applications. In various preferred embodiments, this system envisages a mechanism governed by an actuator for turning the blades from the closing position mentioned above to the opening position—the actuator and the motor being represented schematically by the block A in FIGS. 1 and 2—and a system of elastic means for bringing the blades back from the opening position to the closing position. In various embodiments, as in the one illustrated (see FIGS. 3A and 3B), the mechanism referred to envisages a rod 61 that is linearly mobile, according to a reciprocating motion, provided on which is a series of cam surfaces 61′ that engage a corresponding series of arms 62 fixed in rotation with respect to the blades. As a result of this mutual engagement between the cam surfaces referred to and the corresponding arms, the movement of translation of the rod is converted into a movement of rotation of the arms. Once again in this type of embodiment, elastic elements 64 are provided that act on the above arms or on further arms, which are also connected to the blades to bring the latter back into the closing position.

The device 10 further comprises a structure 8 for collecting the ingredient that is set underneath the loading structure 2 and is in communication with the bottom part thereof so as to receive the ingredient that passes though the valve unit 6. In the embodiment illustrated, this collecting structure is schematically represented in the form of a drawer.

The optical sensor referred to above and designated by the reference number 12, which is designed to detect an optical parameter of the ingredient, is set on the frame 2 so as to face the inside of the chamber 4, into which the ingredient to be dispensed is poured.

The control unit 100 of the device is configured for governing the actuation system of the blades on the basis of the signal received by the sensor, in particular for sending the blades into the opening position only in the case where the ingredient collected in the chamber 4 is recognised, via said sensor, as being the ingredient envisaged by the process. It should in general be noted that, in this type of control, the unit may be configured also to take into account a possible given order with which the process envisages dispensing of the various ingredients and hence be configured for enabling dispensing of the ingredient if and only if this, in addition to corresponding to one of the ingredients envisaged, is also dispensed at the right moment.

For the purposes referred to above, the control unit is programmable in such a way that, for each ingredient to be dispensed, loaded therein are one or more values or ranges of values of the aforesaid parameter detected by the sensor, which are characteristic of the particular ingredient. In operation, the control unit is hence configured for comparing one or more signals obtained from the detection performed by the sensor with the values or ranges of values associated to the ingredient envisaged, and for sending the blades into the opening position whenever a correspondence of the former with the latter is detected.

In various preferred embodiments, the sensor is constituted by a colorimeter designed to provide an indication of the colour of the ingredient by determining the wavelengths of the light reflected thereby. In this case, the reference values loaded into the control unit for each ingredient are indicative of characteristic values or ranges of wavelengths.

Moreover, in various embodiments, as in the one illustrated, the device 10 may also comprise a system for weighing the amount of material introduced into the chamber 4. Preferably, the system is constituted by a series of load cells 16 arranged at the bases of the frame 2. In various preferred embodiments, in addition to the control described above on the type of ingredient, the control unit is configured for subjecting control of the blades also to detection, by the aforesaid weighing means, of the amount of material introduced into the chamber.

The device just described constitutes an extremely versatile independent unit, which can be used in a wide range of applications, in particular both in the context of processes of preparation of dough carried out in bakeries and in the context of automatic processes of an industrial type.

The device described herein may in any case also envisage configurations of another type. In particular, in alternative embodiments, the device may present a configuration that enables integration thereof directly with the line for supply of the ingredients of an industrial plant.

In this regard, in various embodiments, as in the one illustrated (see FIG. 4, where the elements in common with those of the previous embodiment are designated by the same reference numbers), the device 10 may hence comprise a conduit 22 for supplying the ingredient, which is designed to be connected directly to the supply line of the industrial plant. Pneumatic means 24, for example a pump driven by an electric motor, are associated to the conduit, for supplying the ingredient, along the conduit, up to the supply line of the industrial plant. The structure 20 for loading the ingredients communicates with the conduit in such a way that the ingredient poured therein reaches this directly by gravity. In various embodiments, as in the one illustrated, the conduit has a U-shaped portion in which the ingredient poured by the operator into the loading structure accumulates, and set in a position corresponding to this portion is the optical sensor 12 of the device, designed to carry out detection on the ingredient. It should be noted that, in this case, the means for controlling the flow of the ingredient mentioned above are represented by pneumatic means. These are in fact governed by the control unit 100, precisely for generating the flow of supply of the ingredient to the line of the plant only if the control unit verifies, by way of the sensor, that the ingredient contained in the conduit effectively corresponds to the one envisaged in the process. The modalities with which this check is made are evidently the same as those already described above with reference to the previous embodiment, and the control unit is hence configured accordingly, in the same way as already seen above.

Of course, without prejudice to the principle of the invention, the details of construction and the embodiments may vary, even significantly, with respect to what is illustrated herein purely by way of non-limiting example, without thereby departing from the scope of the invention, as is defined in the annexed claims.

1. A device for dispensing an ingredient in the context of a process of preparation of a mixture for making a food product, said device comprising:
an optical sensor designed to detect an optical parameter of said ingredient; and
a control unit configured for generating a signal for enabling dispensing of the ingredient on the basis of a signal coming from said sensor.

2. The device according to claim 1, comprising a structure for loading the ingredient.

3. The device according to claim 2, comprising control means for controlling flow of the ingredient from said loading structure to a structure for receiving the ingredient, wherein said control unit is configured for governing said control means via said enabling signal.

4. The device according to claim 1, wherein said sensor is a colorimeter or a spectrometer.

5. The device according to claim 1, wherein said control unit is configured for governing said control means in the action of determining said flow of the ingredient only in the case where said ingredient is recognised by said unit as a predetermined ingredient, on the basis of the detection made by said sensor.

6. The device according to claim 1, wherein in said unit there are recorded for each ingredient to be dispensed one or more reference values or ranges of reference values of said parameter detected by said sensor, and said control unit is configured for comparing one or more signals obtained via said sensor with said reference values or ranges of reference values, and for governing said control means in the action of determining said flow of the ingredient whenever a given relation of correspondence between said signals and said reference values is detected.

7. The device according to claim 1, wherein said control means are constituted by a valve unit.

8. The device according to claim 7, wherein said valve unit comprises a valve with rotatable blades.

9. The device according to claim 1, wherein said control means are constituted by a pump governed by an electric motor.

10. The device according to claim 3, comprising a system for weighing the amount of ingredient contained in said loading structure, wherein said control unit is configured for generating said enabling signal also on the basis of a signal coming from said weighing system.

11. A method for dispensing an ingredient in the context of a process of preparation of a mixture for making a food product, wherein there is used a dispensing device comprising:
an optical sensor designed to detect an optical parameter of said ingredient; and
a control unit configured for generating a signal for enabling dispensing of the ingredient on the basis of a signal coming from said sensor;
said method comprising the steps of:
detecting via said sensor an optical parameter of said ingredient; and
generating a signal for enabling dispensing of the ingredient only in the case where said ingredient is recognised by said unit as a predetermined ingredient, on the basis of the detection made by said sensor.

12. The method according to claim 11, wherein said device comprises:
a structure for loading the ingredient; and
control means for controlling the flow of the ingredient from the loading structure to a structure for receiving the ingredient; said method comprising the step of:
governing said control means in the action of determining said flow of the ingredient only in the case where said ingredient is recognised by said unit as a predetermined ingredient, on the basis of the detection made by said sensor.

13. The method according to claim 12, comprising the step of detecting the color of said ingredient and of governing said control means in the action of determining said flow of the ingredient in the case where the color detected corresponds to a reference color recorded in said control unit.
